(19) United States
(12) Patent Application Publication
(10) Pub. No.: US 2026/0178979 A1
(43) Pub. Date: Jun. 25, 2026

(54) Systems and Methods for Eliminating Bias in Machine Learning and Artificial Intelligence Systems

(71) Applicant: Insurance Services Office, Inc., Jersey City, NJ (US)

(72) Inventors: Shane De Zilwa, Danville, CA (US); Chun Li, Berkeley, CA (US); Yugandhar Pavan Devarapalli, Ellington, CT (US)

(73) Assignee: Insurance Services Office, Inc., Jersey City, NJ (US)

(21) Appl. No.: 19/430,602

(22) Filed: Dec. 23, 2025

Related U.S. Application Data
(60) Provisional application No. 63/738,295, filed on Dec. 23, 2024.

(51) Int. Cl. G06N 20/00

(52) U.S. Cl. CPC G06N 20/00

(57) ABSTRACT

Systems and methods for eliminating bias in machine learning systems are disclosed. The system includes a bias detection/correction computer system that executes a model bias detection and correction software engine. The model bias detection and correction software engine selects and executes an existing ML/AI model, and receives and processes the model output to detect representation bias using a first detection algorithm and accuracy bias using a second detection algorithm. The engine then calculates a score correction value which is based on the detection results of the first and second detection algorithms, and corrects output of the model using the score correction value. Optionally, the score correction value could be utilized for re-training of the model in order to reduce or eliminate bias in future usage of the model.

### RELATED APPLICATIONS

The present application claims the benefit of U.S. Provisional Application Ser. No. 63/738,295 filed on Dec. 23, 2024, the entire disclosure of which is expressly incorporated herein by reference.

### BACKGROUND

### Technical Field

The present disclosure relates generally to the fields of machine learning and artificial intelligence. More specifically, the present disclosure relates to systems and methods for eliminating bias in machine learning and artificial intelligence systems.

### Related Art

In today's rapidly growing fields of machine learning (ML) and artificial intelligence (AI), the elimination of bias in such systems, such as representation bias and accuracy bias, is of significant concern. Representation bias occurs when a machine learning model fails to provide outputs that equally represent protected groups of individuals (e.g., individuals of certain races, ethnicities, or other selected characteristics) versus base groups. Accuracy bias occurs when a machine learning model generates results that are less accurate for individuals of protected groups versus individuals from base groups. Both representation bias and accuracy bias can result in ML and AI systems generating unfair outcomes, thereby diminishing the value of such systems in a variety of fields, including, but not limited to, insurance and actuarial fields (among others).

Accordingly, what would be desirable are systems and methods for eliminating bias in machine learning and artificial intelligence systems which address the foregoing and other needs.

### SUMMARY

The present disclosure relates to systems and methods for eliminating bias in machine learning systems. The system includes a bias detection/correction computer system that executes a model bias detection and correction software engine. The model bias detection and correction software engine selects and executes an existing ML/AI model, and receives and processes the model output to detect representation bias using a first detection algorithm and accuracy bias using a second detection algorithm. The engine then calculates a score correction value which is based on the detection results of the first and second detection algorithms, and corrects output of the model using the score correction value. Optionally, the score correction value could be utilized for re-training of the model in order to reduce or eliminate bias in future usage of the model.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating hardware and software components of the systems and methods of the present disclosure;

FIG. 2 is a flowchart illustrating process steps carried out by the systems and methods of the present disclosure;

FIGS. 3-4 are tables illustrating representation bias addressed by the systems and methods of the present disclosure;

FIG. 5 is a graph of receiver operating characteristic (ROC) curves illustrating operational results generated by the systems and methods of the present disclosure;

FIGS. 6-7 are tables illustrating age bias addressed by the systems and methods of the present disclosure in connection with a property machine learning model;

FIG. 8 is a graph visualizing age disparity associated with the data of FIGS. 6-7;

FIGS. 9-10 are tables illustrating gender bias addressed by the systems and methods of the present disclosure in connection with a property machine learning model;

FIG. 11 is a graph visualizing gender disparity associated with the data of FIGS. 9-10;

FIGS. 12-13 are tables illustrating race bias addressed by the systems and methods of the present disclosure in connection with a property machine learning model;

FIG. 14 is a graph visualizing race disparity associated with the data of FIGS. 12-13;

FIG. 15 is a table illustrating race bias mitigation performed on a model in accordance with the systems and methods of the present disclosure; and

FIG. 16 is a graph visualizing mitigation associated with the data of FIG. 15.

### DETAILED DESCRIPTION

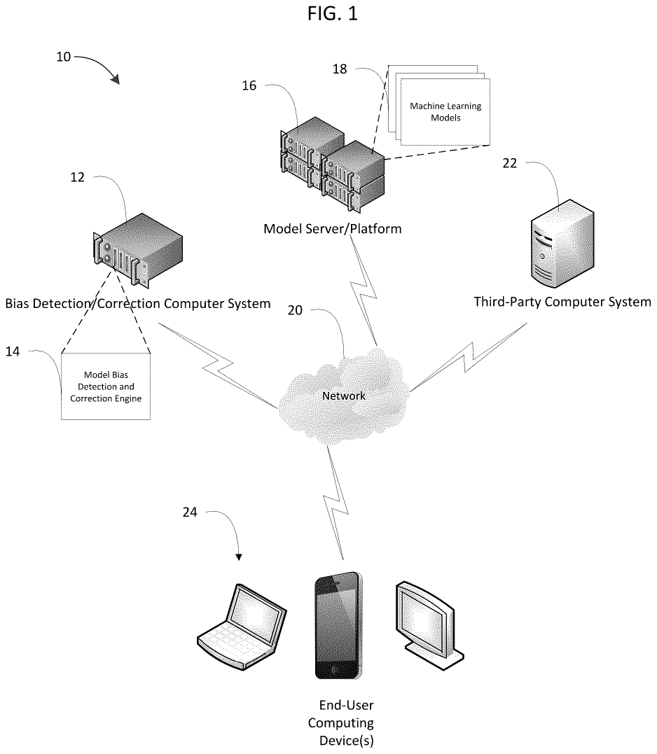

The present disclosure relates to systems and methods for eliminating bias in machine learning systems, as described in detail below in connection with FIGS. 1-16.

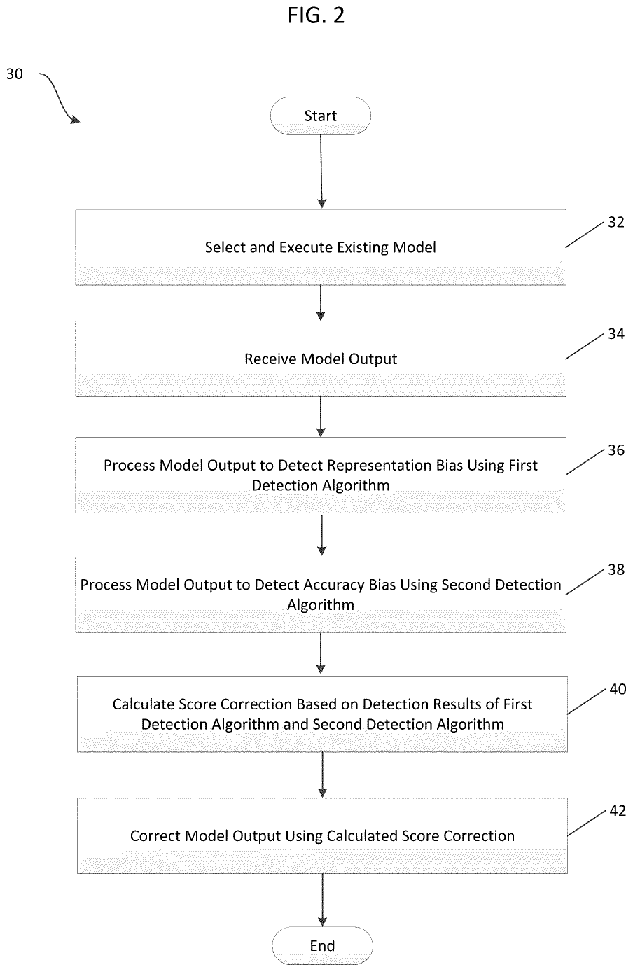

FIG. 1 is a diagram illustrating hardware and software components of the systems and methods of the present disclosure, indicated generally at 10. The system 10 includes a bias detection and correction computer system 12 which executes a model bias detection and correction software engine 12 that performs the bias elimination processes disclosed herein. As will be discussed in greater detail below in connection with FIG. 2, the engine 12 selects and executes a machine learning model, detects representation bias and accuracy bias in outputs generated by the model, and generates a model score correction value which is used to eliminate the detected representation bias and accuracy bias of the model. The machine learning model could be provided by a model server/platform 16 which could include a plurality of machine learning models 18 and which could communicate with the system 12 via a network 20, such as the Internet, an intranet, a wide area network, a local area network, or other suitable communications network. Still further, the system 12 could communicate via the network 20 to a third-party computer system 22 (e.g., an insurer computer system) and one or more end-user computing devices 24 for various purposes, such as allowing users to interact with the system 12 and/or to generate and/or display bias elimination score corrections generated by the system 12.

Both the system 12 and model server/platform 16 could be hosted on a suitable cloud-computing platform, and/or they could be stand-alone computer systems (e.g., personal computers, servers, laptop computers, tablet computers, mobile devices, etc.). The end-user computing devices 24 and the third-party computer system 18 could include personal computers, servers, smart phones, laptop computers, table computers, mobile devices, etc. The engine 14 could comprise computer-readable instructions stored on one or more non-transitory, computer-readable media and coded in a suitable high- or low-level computer programming language, including, but not limited, C, C++, C#, Java, Javascript, Python, or any other suitable programming language.

FIG. 2 is a flowchart illustrating process steps, indicated generally at 30, carried out by the engine 14 of FIG. 1. Beginning in step 32, the system selects and executes an existing machine learning model. Such a model could be selected from, and/or executed by, the model server/platform 16 of FIG. 1. Next, in step 34, the system receives output from the executed model. In step 36, the system processes the model output to detect representation bias using a first detection algorithm. More specifically, the first detection algorithm can detect whether a model gives an equal representation of a protected group versus a base group. For example, in connection with detecting representation bias in connection with a fraud machine learning model, the first detection algorithm could operate as follows: if a use fraud model refers to a top 2% high score population, representation bias could be detected where a minority race group has less representation than a white race group in terms of a percentage meeting a pre-defined cutoff within that group. The first detection algorithm could detect representation bias (expressed as a predicted prevalence ratio) by measuring a ratio of predicted target rates for the protected group over the predicted target rates for the base group, and cutoffs could be defined if the ratio is between 0.8 and 1.25. The first detection algorithm could be coded using “hard-wired” logic rules, heuristics, and/or using machine learning techniques.

In step 38, the system processes the model output to detect accuracy bias using a second detection algorithm. The second detection algorithm can detect whether the accuracy of the model is lower for a protected group than for a base group, which would generate higher false positives for the protected group in comparison to the base group. The second detection algorithm could detect accuracy bias (expressed as a false discover ratio) by measuring the ratio of false discovery rate of the protected group over the base group, and cutoffs could be defined in the ratio is between 0.8 and 1.25. The second detection algorithm could be coded using “hard-wired” logic rules, heuristics, and/or using machine learning techniques.

In step 40, the system calculates a model score correction value based on the detection results of the first detection algorithm and the second detection algorithm. For example, for each protected group, a percentile score/rank can be generated by the system relative to scores within the same group (so that, cross-groups, a protected group is not compared unfairly with the base group). The calculated score/rank represents a mitigated model score that has no bias. Finally, in step 42, the system corrects the model output using the calculated model score correction value. For example, a threshold could be set by the system to select the top suspicious records as the model-predicted tags (e.g., a threshold could be set at 0.9, which is the cutoff for the top 1%; with the new corrected value, the top 1% of each protected group and the base group are labeled respectively as model-predicted tags). Advantageously, by applying a post-processing score correction to the model, the system alleviates and/or eliminates bias without requiring re-training of the model, while model accuracy is minimally impacted. This also saves computational time and complexity in that re-training of the model (which is generally computationally expensive and time-consuming) is not required in order for bias to be eliminated or alleviated from the model. Of course, optionally, the calculated model score correction value could be used to re-train the model, if desired, so that bias is eliminated from the model in future usage of the model.

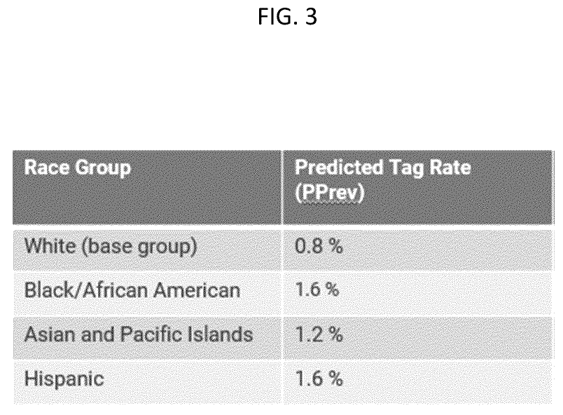

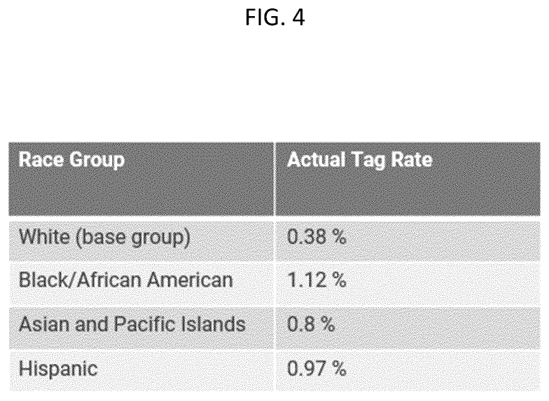

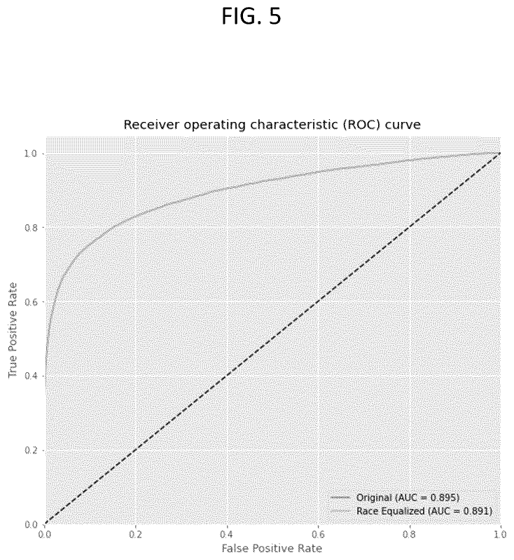

FIGS. 3-4 are tables illustrating representation bias addressed by the systems and methods of the present disclosure. FIG. 3 indicates the predicted tagging rate (e.g., tagging by the machine model of data representing potentially adverse events) for various race groups for a given model that was processed by the systems and methods of the present disclosure, and FIG. 4 shows the actual tagging rate that was performed by the model. As can be seen, the tagging rates (both predicted and actual) are substantially less for the base (white) race group than for the protected (non-white) race groups, which indicates that bias exists in the data being processed by the machine learning model. Such bias is compensated for by the system and methods of the present disclosure after modeling (using post-processing score correction), without major adverse effects on the modeling system as illustrated by the receiver operator characteristics (ROC) curves illustrated in FIG. 5. As shown, the ROC curves (comparing the original model outputs with the race-equalized outputs (generated using the score correction of the present disclosure) indicate nominal negative effect on overall model accuracy while alleviation of representation bias.

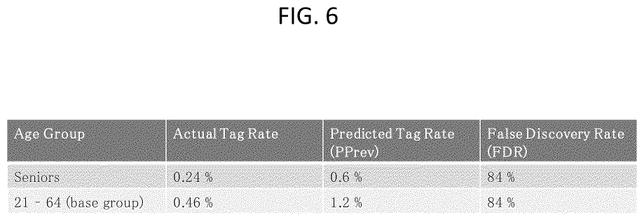

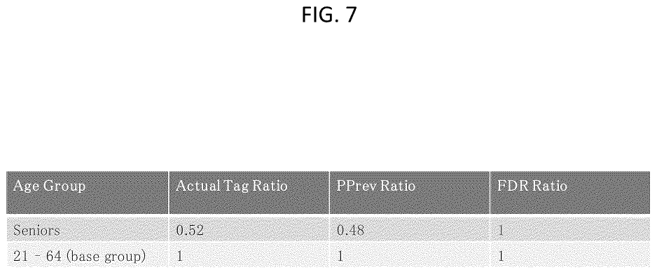

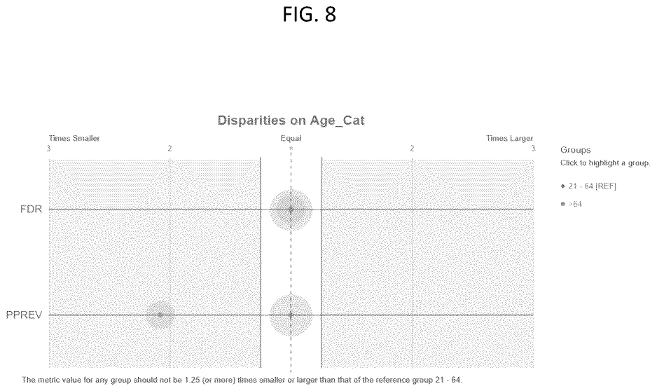

FIGS. 6-7 are tables illustrating age bias addressed by the systems and methods of the present disclosure in connection with a property machine learning model. The property model was found to have exhibited no accuracy or representation bias against female seniors (over 65 years of age), no accuracy bias against protected race groups, but significant representation bias against protected race groups. An out-of-time model validation dataset was used, wherein the following property claims were dropped from the dataset: claims without adequate information on a policy holder's date of birth, claims without adequate information on the policy holder's race assignment, and claims with unknown or unidentifiable gender assignment. The dropped population did not significantly differ from the retained population in terms of the tag rate, and the top 1% was scored as the predicted target (actual tag rate being 0.5%). The data of FIGS. 6-7 is visualized in FIG. 8.

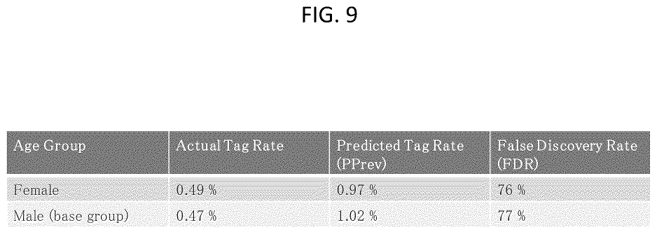

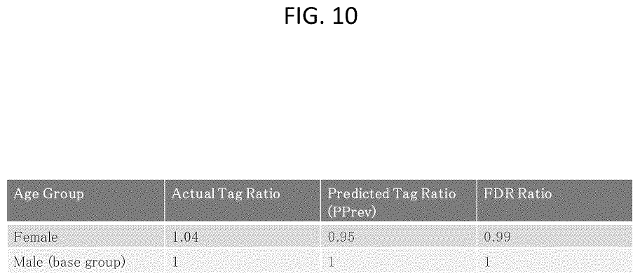

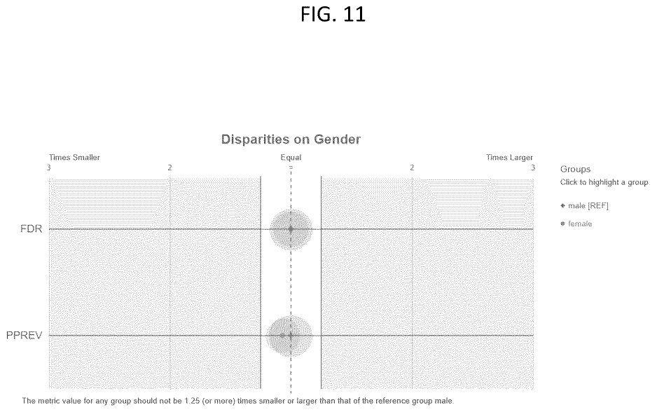

FIGS. 9-10 are tables illustrating gender bias addressed by the systems and methods of the present disclosure in connection with a property machine learning model, and FIG. 11 is a graph visualizing gender disparity associated with the data of FIGS. 9-10. The systems and methods of the present disclosure can be applied to alleviate the gender bias in the property machine learning model.

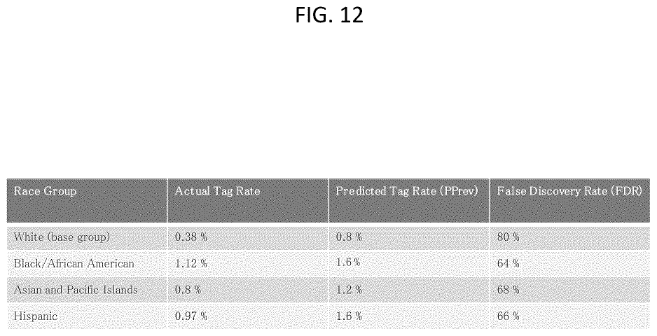

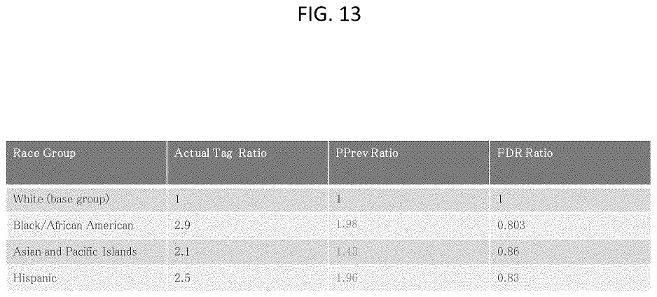

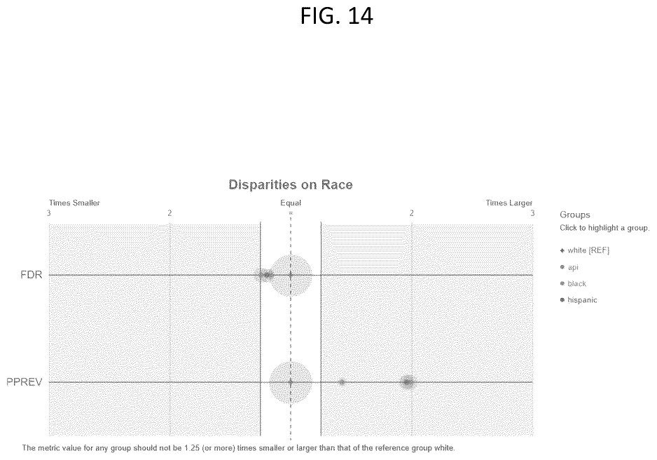

FIGS. 12-13 are tables illustrating race bias addressed by the systems and methods of the present disclosure in connection with a property machine learning model. FIG. 14 is a graph visualizing race disparity associated with the data of FIGS. 12-13. The systems and methods of the present disclosure can be applied to alleviate the race bias in the property machine learning model.

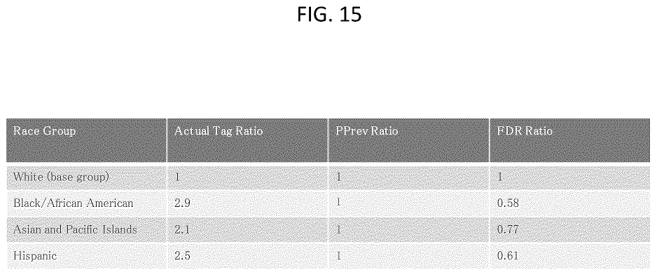

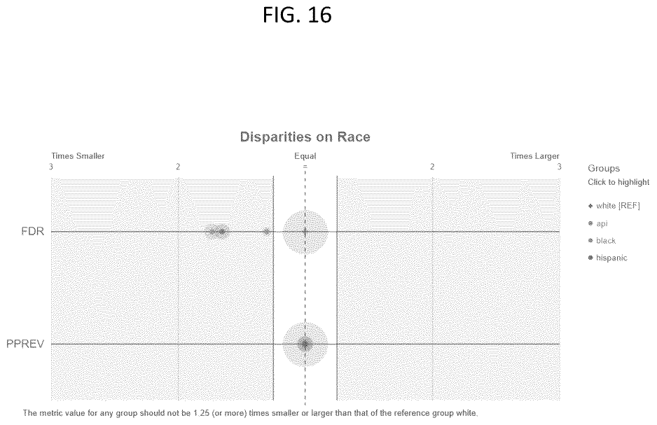

FIG. 15 is a table illustrating race bias mitigation performed on a model in accordance with the systems and methods of the present disclosure. For race bias mitigation, the system uses a 1% threshold for each of the race groups instead of a single (overall) threshold of 1% for predicted fraud tag, which eliminated representation bias and accuracy bias for the protected groups. As can be seen, the fraud capture rate decreased from 48.7% to 47.5%. Both gender bias (female) and age bias (seniors) tests passed after mitigation by the systems and methods of the present disclosure. The post-mitigation race disparity visualization is shown in FIG. 16.

While the systems and methods of the present disclosure have been discussed herein in connection with eliminating bias in connection with machine learning and artificial intelligence models, the systems and methods herein could be applied to eliminate bias in other types of computing models, such as predictive models, regression models, and other types of computer models where modeling is achieved but machine learning does not take place.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A system for eliminating bias in machine learning and artificial intelligence systems, comprising:
a bias detection and correction computer system; and
a model bias detection and correction software engine executed by the bias detection and correction computer system, the model bias detection and correction software engine causing the bias detection and correction computer system to:
select and execute a machine learning or artificial intelligence model;
receive and process output of the model to detect representation bias using a first detection algorithm;
receive and process output of the model to detect accuracy bias using a second detection algorithm;
calculate a score correction value based on detection results of the first and second detection algorithms; and
correct output of the model using the score correction value.

2. The system of claim 1, wherein the software engine causes the bias detection and correction computer system to re-train the model using the score correction value in order to reduce or eliminate bias in future usage of the model.

3. The system of claim 1, wherein the first detection algorithm detects whether the model gives an equal representation of a protected group versus a base group.

4. The system of claim 3, wherein the first detection algorithm detects whether a minority race group has less representation than a white race group based on a predefined cut-off.

5. The system of claim 3, wherein the first detection algorithm measures a ratio of predicted target rates for the protected group over a predicted target rate for a base group and defines a cutoff based on the ratio.

6. The system of claim 1, wherein the second detection algorithm detects whether accuracy of the model is lower for a protected group than for a base group.

7. The system of claim 6, wherein the second detection algorithm measures a ratio of false discovery rates for a protected group over a base group and defines a cutoff based on the ratio.

8. A method for eliminating bias in machine learning and artificial intelligence systems, comprising:
selecting and executing a machine learning or artificial intelligence model;
receiving and processing output of the model to detect representation bias using a first detection algorithm;
receiving and processing output of the model to detect accuracy bias using a second detection algorithm;
calculating a score correction value based on detection results of the first and second detection algorithms; and
correcting output of the model using the score correction value.

9. The method of claim 8, further comprising re-training the model using the score correction value in order to reduce or eliminate bias in future usage of the model.

10. The method of claim 8, wherein the first detection algorithm detects whether the model gives an equal representation of a protected group versus a base group.

11. The method of claim 10, wherein the first detection algorithm detects whether a minority race group has less representation than a white race group based on a predefined cut-off.

12. The method of claim 10, wherein the first detection algorithm measures a ratio of predicted target rates for the protected group over a predicted target rate for a base group and defines a cutoff based on the ratio.

13. The method of claim 8, wherein the second detection algorithm detects whether accuracy of the model is lower for a protected group than for a base group.

14. The method of claim 13, wherein the second detection algorithm measures a ratio of false discovery rates for a protected group over a base group and defines a cutoff based on the ratio.
